(19) United States
(12) Patent Application Publication
(10) Pub. No.: US 2022/0061305 A1
(43) Pub. Date: Mar. 3, 2022

(54) UNIVERSAL ROLLING TRAP FOR MOUSE AND RAT

(71) Applicant: Jakko H Yang, Pleasanton, CA (US)

(72) Inventor: Jakko H Yang, Pleasanton, CA (US)

(21) Appl. No.: 17/006,861

(22) Filed: Aug. 30, 2020

(51) Int. Cl. A01M 23/10

(52) U.S. Cl. CPC A01M 23/10; A01M 2200/00

(57) ABSTRACT

A mechanical trap includes an ultra light carbon fiber hollow tube roller on a pairs of pillow block bearings and adapters. It can be easily mounted on top of a water container. Bait is placed in the middle section of the roller. When a mouse or a rat climbs on the roller and try to reach and eat bait, the ultra sensitive roller will become unstable, self-triggered and start rolling. The mouse or rat will quickly lose balance and then fall into water container underneath. Water depth in the container will determine whether the mouse or rat will be captured alive or killed from drowning. The trap can have an adapter and adjustable length to universally fit different kinds of water container of different sizes. It can quickly trap or kill multiple different sizes of mice and rats. It is simple, low-cost, easy to operate, durable and environmental friendly.

### FIELD OF THE INVENTION

The present invention relates generally to animal traps and more particularly to traps for house or field mice and rats etc.

### BACKGROUND OF THE INVENTION

Humans have been having mouse and rat problems for thousands of years. In the past people mostly rely on predator on upper food chain to control population of mouse and rat.

In modern days, once a home, warehouse, restaurant, hotel, supermarket, farm, or commercial establishment etc is infested with rats or mice, control of the population of such mice and rats becomes extremely difficult. It is well known that they are dangerous to the human beings because they are not only destructive but also are responsible for harboring and transmitting a number of serious diseases.

What makes situation worse is that each mouse can contaminate ten times more food than it eats, and each pair of mice could produce as many as 200 offspring in four months.

Besides natural predator, there are two categories of ways to control mouse and rat population. One is toxic way by using chemical poisonous baits; the other is non-toxic by using electric, mechanical energy release. There is a trend that toxic way can no longer be accepted in some places in the world.

In non-toxic ways, only two specific kinds of products in the market have commercial success. One is electric mouse trap at which a mouse or a rat can be killed by high voltage electrical shock when a mouse or rat enter trap box to eat bait, another is mechanical trap at which a mouse or a rat can be killed by spring potential energy release when it is trigged by eat bait. However, both are sub-category of single-shot type. Only one of mice and rats can be killed per apparatus load in general. And that is usually one load per day. For heavily infested areas this kind of efficiency of one-kill-per-day for one apparatus is quite low. It also takes some effort for a person to reload apparatus after either a real kill or a miss-trigger.

Therefore, there is a long-felt need for control mouse and rat population with high efficiency using environment friendly method. This need is well recognized, persistent and has not been resolved by others.

It would be good if there is a novel apparatus that can do multiple-kills-per-day for one apparatus, say killing more than 20 mice and rats per day.

In the past, there are so many different mouse and rat traps with different mechanical structures that have been disclosed. But most of them are still lack of commercial success. Therefore, in this very crowded art, any advance of apparatus or method would definitely carry weight.

Recently there is an apparatus product of prior art is available on sale at internet on-line market place. It is called “Rolling Mouse Trap” that can kill more than ten mice or rats per night.

In the apparatus product of prior art, it comprises four essential elements: a center rod with a fixed length, two plastic plain bearings, a metal roller of a fixed length and one or two sets of rubber trigger rings; plus some accessories.

However, there are a number of disadvantages in the prior art.

The first disadvantage of prior art is that apparatus has very limited sensitivity due to roller material selection. Based on scientific principle of conservation of momentum, if a heavier object interacts with lighter object, the lighter object tends to have higher speed after reaction. Higher motion speed means unstable. For example, a person can walk on a heavy rowboat much easier than that on a light rowboat because light rowboat moves too fast so that it is unstable. For the same reason, a mouse or a rat can climb along a heavier roller easier than that of a lighter roller. The heavier roller, the more stable it is, more difficult to trap a mouse or rat. One measurement of rotational stability is called rotational inertia. In fact, rotational inertia of hollow roller would quadruple if radius doubles. Selection of heavier metal materials in the prior art itself teaches away from the well established scientific principles. To be a good mouse and rat trap, roller being able to rotate freely alone is not sufficient, weight of roller also matters.

The second disadvantage of prior art is that it needs one or two pieces of rubber trigger ring with much larger diameter to stay with roller. Because metal roller is inherently heavier and stable a mouse or rat can stay on the roller without fall. When a mouse or rat is trying to cross larger diameter rubber ring to reach bait, roller will start rolling and a mouse or rat will lose balance. It is intended to trigger an event of rolling. Adding larger diameter rubber material on roller itself would actually make roller even more insensitive due to increase of rotational inertia of the roller. In fact, need of trigger ring itself is an evidence that the prior art has limited sensitivity.

The third disadvantage of prior art is that trigger rubber will actually hinder mouse and rat from reaching bait. Animals usually tend to go for food that is easier to be reached. Because food bait is hiding behind a trigger rubber ring, barrier of rubber would slow down trapping or killing process.

The fourth disadvantage of prior art is that it has an effective limitation on mouse and rat size. From its product on-line video advertisement, it is an observation that most mice and rats trapped are those of smaller sizes. Larger ones are either not willing to climb along the smaller diameter rod, or are easy to escape. Therefore, the embodiment in prior art is for trapping smaller mice and rats.

The fifth disadvantage of prior art is that it is not scalable. If apparatus in the prior art is to trap larger mice and rats, it would be necessary to make roller longer and make diameter larger. By doing this it will make the apparatus even heavier, more stable and less sensitive. At some point, it could trap larger ones but it cannot trap smaller anymore. To make diameter larger means that rotational inertia increases even faster. It becomes not suitable for trapping smaller mice and rats any more in general.

The sixth disadvantage of prior art is that it can only fit particular water bucket or container due to its fixed length. It is not intended to be a universal apparatus. From its advertisement it appears that it actually only works with water bucket of particular size.

The seventh disadvantage of prior art is that it needs tools to drill correct holes with correct drill-bit size at correct location of correct size water bucket in order for center rod to go through. For many people drilling holes at right plastic water buckets at right place with right drill bit is already a major engineering project. This kind of product design will hurt its market share.

The eighth disadvantage of prior art is that it may not work for some kind of aquarium tank or water containers at all. For example, acrylic material, ceramic material will all crack under machine drill. Soft plastic water bag, soft rubber water bag etc. will not work well either under machine drill.

The ninth disadvantage of prior art is that there will damages on property involved in hole drilling by machine drill. After holes were drilled at a bucket, the bucket then become mouse and rat trap specific bucket and most likely it cannot be used for other general purposes.

The tenth disadvantage of prior art that people may not be willing to modify the tank or container just for mouse or rat trap only purpose. It will further hurt deployment of apparatus in market. People simply want a product of ease to use.

The eleventh disadvantage of prior art is that metal material may get rusty over time. Metal tends to get rusty over the time. Even it is galvanized. The life time of the apparatus will be limited.

The twelfth disadvantage of prior art is that it potentially generates a vicious circle. The heavier the roller gets, the more insensitive it becomes, so prior art adds one or more trigger rubber ring, which makes the roller system rotational inertia even larger and even more insensitive yet. In addition, if the roller system is not sensitive, it is possible that bait on roller is consumed by a mouse or rat without been triggered and been trapped so that more bait would be put on roller, which makes roller even heavier and more insensitive.

While the prior art has disadvantages, here is current invention that has following advantages.

The first advantage of the current invention is that the new type of apparatus is extremely light and sensitive in the beginning by design. Recently technology advance makes high strength and ultra light weight composite material available in aerospace and automobile industry. Nowadays people can fabricate a machine part of various shapes using ultra light carbon fiber with relatively low cost. Specific gravity of carbon fiber is only 1.8 while specific gravity of steel is 7.8 and that of aluminum is 2.7. Roller made of ultra light carbon fiber tube is inherently ultra light-weighted. Based on the same size, the roller with carbon fiber is four times more sensitive than that of steel.

The second advantage of the current invention is that there is no need for a rubber trigger ring. Carbon fiber roller could be much lighter than the smallest house mouse and rat. It is extremely difficult for a mouse or rat to keep balance on a rotating carbon fiber roller. As soon as it climbs on the roller, it will automatically trigger roller to roll. Therefore, one critical element of trigger rubber is omitted in current invention.

The third advantage of the current invention is that capturing or killing process is becoming faster. The best scenario would be that a hungry greedy mouse or rat climbs on the roller and is about to reach the bait and then roller starts rolling and the mouse or rat then immediately loose balance and falls into water container. Faster means more, more means higher efficiency.

The fourth advantage of the current invention is that it is intended for all types of common water containers, not just a particular type of bucket. It can universally used in every part of world in normal conditions. The apparatus of current invention is intended to be sold worldwide.

The fifth advantage of the current invention is that single apparatus can universally trap or kill mouse and rat with much wider range of sizes. The nose-to-anus size of a mouse and rat can be about 70 mm for small ones and about 200 mm for larger ones. They are all within the range of the apparatus of current invention. People can also make roller diameter slightly larger without losing sensitivity so that mouse and rat more willing to climb. In general, animals would feel “safer and more stable” when climbing on a larger object.

The sixth advantage of the current invention is that no additional installation tools are needed. There is no center rod needed in current invention. Instead, current invention is able to overcome prior art by using the light carbon fiber roller for dual purposes of both holding and rolling. Therefore, another critical element is omitted. The different architecture leads to a different structure and different product characteristics. This is a one of clear distinctions.

The seventh advantage of the current invention is that installation is easier. There are two pillow block bearings that are used. Pillow block bearings with adapters can easily sit on top edge of an open water container. Pillow block bearings can also sit on a platform surface outside of an open water container.

The eighth advantage of the current invention is that there is no damage on any properties during installation. After an water container is used for mouse and rat trapping and killing purpose, the water container can be reused as original purpose. This is very important marketing strategy too.

The ninth advantage of the current invention is that due to the nature of universality a lot more people are willing to buy and use the apparatus. This will lower the manufacture cost per apparatus.

The tenth advantage of the current invention is that it potentially generates a virtuous circle. The lighter the roller gets, the more sensitive it becomes, so trap more mouse and mouse quicker before bait is touched. The bait consumption on roller is far less or no consumption at all, so less bait would be put on roller, which makes roller even lighter and more sensitive. Bait is usually peanut butter that can be applied directly on roller.

The eleventh advantage of the current invention is that it is well known that carbon fiber is water, UV light resistant, weather resistant. So lifetime of apparatus can be very long.

The twelfth advantage of the current invention is that if area is so infested, people can vary length and container size in different days to make sure mouse and rat can be eliminated. After one day of using a smaller water container, they can try medium container in next day, finally they can try larger container.

Therefore, the current invention solves several problems that prior arts have.

### SUMMARY OF THE INVENTION

A universal mechanical mouse and rat trap that can be used to rapidly trap or kill multiple mice and rats etc is presented. It is simple, low-cost, easy to operate, durable and environmental friendly. It also allows for sanitary disposal of a plurality of the trapped or dead mice, rats without contact to humans. It is particularly useful in heavily infested areas. The trap has a roller on a pairs of pillow block bearings with adapters at both ends mounted on top of a water container. The roller is made of ultra light weight material like carbon fiber to make the roller ultra sensitive. It can have an adjustable length to universally fit different kinds of container of different sizes. It can trap or kill different sizes of mice and rats. Bait is placed in the middle section of the roller. When a mouse or rat climbs on the roller and try to reach and eat bait the sensitive roller will become unstable, self-triggered and start rolling. The mouse or rat will quickly lose balance and then fall into water container underneath. Depth of water in the container will determine whether the mouse or rat will be captured alive or killed from drowning.

### BRIEF DESCRIPTION OF THE DRAWINGS

FIG. 1 shows that the universal rolling trap for mouse and rat can be adjusted to have specific length in order to be mounted between two generic platforms where a water container can be placed in the middle underneath.

FIG. 2 shows a various sizes of ultra-light carbon fiber hollow tubes can be telescoped together, either from one side or from both sides.

FIG. 3 shows a typical set of pillow block bearing for mounting carbon fiber hollow tube.

FIG. 4 shows that the universal rolling trap for mouse and rat can be also mounted on top of a standard household water bucket using two pieces of bearing-to-container adapters and two pieces of guide ramps.

### DETAILED DESCRIPTION OF THE PRESENT INVENTION

The present invention is about a universal rolling trap to kill or catch mouse and rats. It has a low cost, high sensitivity.

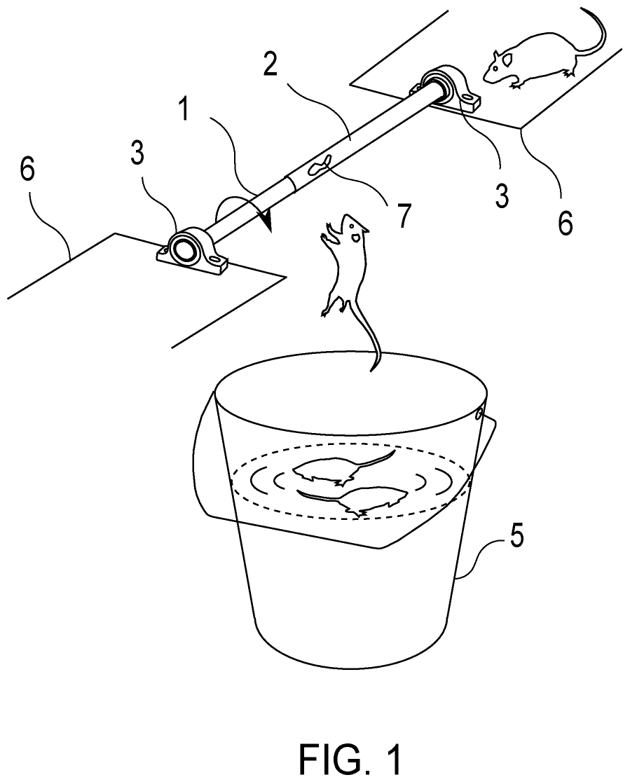

Referring FIG. 1, it shows that the universal rolling trap for mouse and rat can be mounted in a pair of generic platforms 6 where a water container 5 can be placed in the middle underneath. Two sets of pillow block bearings 3 can be mounted in the generic platforms 6 without using bearing-to-container adapters 4. One of the best low cost bait 7 is fresh peanut butter that is sticky and can be put on inner carbon fiber hollow tube 1 or outer carbon fiber hollow tube 2 easily. Peanut butter bait 7 will stay with inner carbon fiber roller tube 1 or outer carbon fiber roller tube 2 well.

Mice and rats have a super sense of smell. They will go for peanut butter bait 7. They can easily locate the bait 7 and then climb along either inner carbon fiber roller tube 1 or outer carbon fiber roller tube 2. They can maintain balance if rear legs are still outside of the roller. However, carbon fiber material is much lighter than mice and rats. Once all legs are on roller, balance is difficult to maintain. Once mice and rats start losing balance, imbalance will accelerate and mice and rats will lose more balance very quickly. Finally mice and rats have no choice but fall from either inner carbon fiber hollow tube 1 or outer carbon fiber hollow tube 2 into water container 5 underneath.

Mice and rats are not good swimmers. If water depth is larger than their body length excluding tail they will be drowned to death. If water depth is less than body length, mice and rat might be caught alive. The best scenario is that mice and rats fall before they begin to actually eat the bait 7 so that bait is saved to catch more mice and rats without bait consumption.

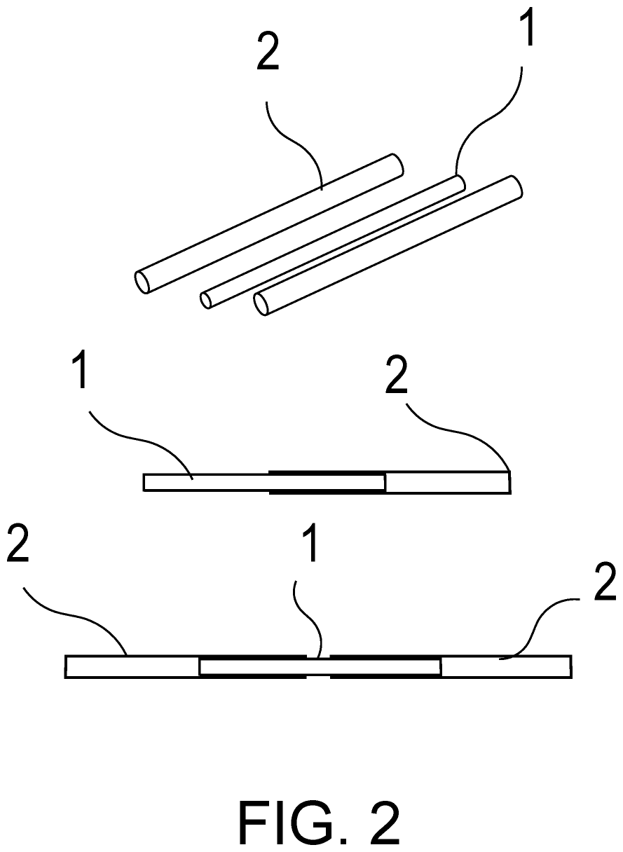

FIG. 2 shows different sizes of carbon fiber hollow tubes. Nowadays carbon fiber hollow tubes can be fabricated with high volume at very low price. The tube with 0.5 mm-1 mm wall thickness is very strong, robust and very popular already. Smaller size inner carbon fiber hollow tube 1 can be easily slide fit into larger size outer carbon fiber hollow tube 2 by telescoping fit. Therefore, total tube length can be adjustable to catch different sizes of mice and rats.

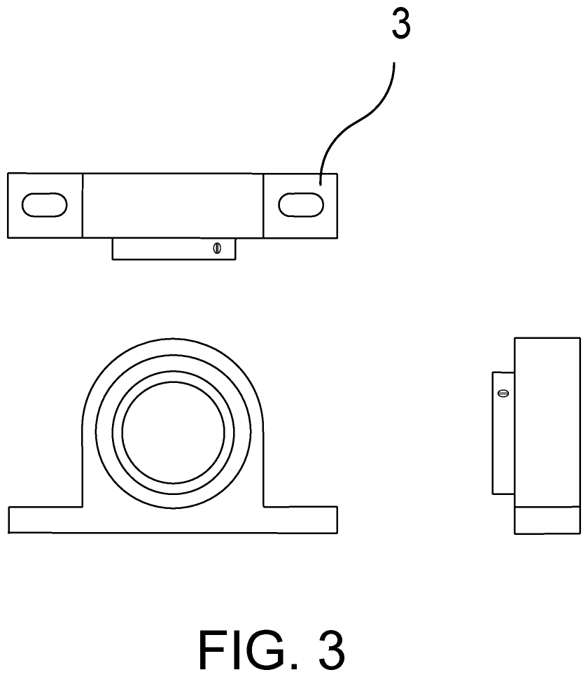

FIG. 3 shows a typical set of low cost pillow block bearing 3. Unlike other primitive bearing in prior arts, in this kind of bearings inner part can freely rotate while outer part of bearings is on holder. Therefore, either inner carbon fiber hollow tube 1 or outer carbon fiber hollow tube 2 can be mounted into inner rotational ring of a set of pillow block bearing 3.

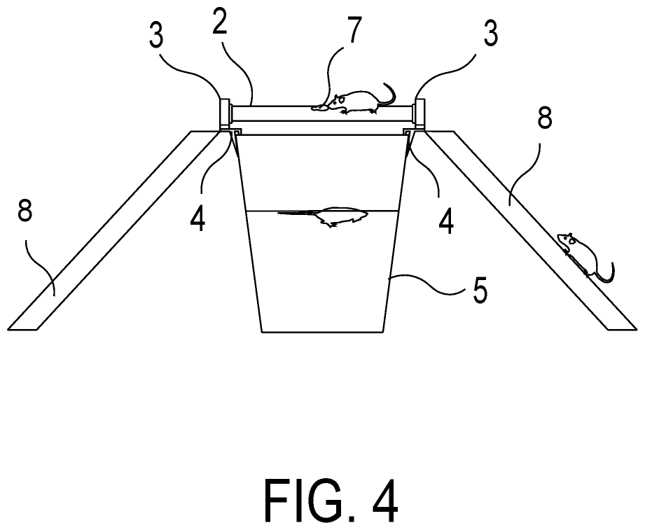

FIG. 4 shows a popular household setup. This kind of household bucket as water container 5 is widely available. A set of pillow block bearing 3 can be easily mounted at edge of bucket or other water tank by using a bearing-to-container adapter 4. The bearing-to-container adapter 4 has a structure to allow pillow block bearing 3 to sit the edge of water container 5 of household bucket. The trap can be easily setup using a household bucket and two pieces of guide ramps 8. These guide ramps 8 can be easily set up using two pieces of low cost lumber.

What is claimed is:

1. A universal rolling trap for mouse and rat comprising:
a round carbon fiber hollow tube having a first end and a second end;
a first set of pillow block bearing connected to said first end of said round carbon fiber hollow tube; and
a second set of pillow block bearing connected to said second end of said round carbon fiber hollow tube.

2. A universal rolling trap for mouse and rat comprising:
a telescoping round carbon fiber hollow tube having a first end and a second end;
a first set of pillow block bearing connected to said first end of said telescoping round carbon fiber hollow tube; and
a second set of pillow block bearing connected to said second end of said telescoping round carbon fiber hollow tube.

3. A universal rolling trap for mouse and rat comprising:
a round carbon fiber hollow tube having a first end and a second end;
a first set of pillow block bearing connected to said first end of said round carbon fiber hollow tube;
a second set of pillow block bearing connected to said second end of said round carbon fiber hollow tube;
a first adapter element mounted to base of said first pillow block bearing, said first adapter element having a structure to be mounted on top of edge of a water container; and
a second adapter element mounted to base of said second pillow block bearing, said second adapter element having a structure to be mounted on top of edge of said water container.

4. A universal rolling trap for mouse and rat comprising:
a telescoping round carbon fiber hollow tube having a first end and a second end;
a first set of pillow block bearing connected to said first end of said telescoping round carbon fiber hollow tube;
a second set of pillow block bearing connected to said second end of said telescoping round carbon fiber hollow tube;
a first adapter element mounted to base of said first pillow block bearing, said first adapter element having a structure to be mounted on top of edge of a water container; and
a second adapter element mounted to base of said second pillow block bearing, said second adapter element having a structure to be mounted on top of edge of said water container.
